(19) United States
(12) Patent Application Publication
(10) Pub. No.: US 2008/0310393 A1
(43) Pub. Date: Dec. 18, 2008

(54) Wireless synchronizing bridging device, wireless synchronizing bridging system and wireless synchronizing bridging method

(75) Inventors: Cheng-Yue Chang, Taipei County (TW); Jeng-Chun Chen, Taipei City (TW)

Correspondence Address: BIRCH STEWART KOLASCH & BIRCH, PO BOX 747, FALLS CHURCH, VA, 22040-0747, US

(73) Assignee: Arcadyan Technology Corporation

(21) Appl. No.: 11/812,036

(22) Filed: Jun. 14, 2007

(51) Int. Cl. H04J 3/06; G06F 13/00

(52) U.S. Cl. 370/350; 710/304

(57) ABSTRACT

A wireless synchronizing bridging device, which operates in conjunction with an electronic device and a mobile terminal device having a connecting interface, includes a connecting interface module, a signal transforming module and a wireless transceiving module. The mobile terminal device electrically connected with the connecting interface module through the connecting interface transmits a connecting interface signal to the connecting interface module. The signal transforming module electrically connected with the connecting interface module transforms the connecting interface signal into a wireless communication signal. The wireless transceiving module electrically connected with the signal transforming module transmits the wireless communication signal to the electronic device. A wireless synchronizing bridging system and a wireless synchronizing bridging method are also disclosed.

### BACKGROUND OF THE INVENTION

1. Field of Invention

The invention relates to a wireless synchronizing bridging device, a wireless synchronizing bridging system and a wireless synchronizing bridging method.

2. Related Art

With the development of the technology, many electronic devices have been upgraded and are available in the market wherein mobile terminal devices, such as a personal digital assistant (PDA), a smart phone, a PDA mobile phone and an audio-video player, have become the hot products. These mobile terminal devices not only make the human life more convenient but also enrich the human life.

In order to make these mobile terminal devices be used more easily, the manufacturer also has developed a synchronizing bridging device, such as a dock base, so that the mobile terminal device may be electrically connected with an electronic device, such as a computer, through the synchronizing bridging device. Thus, files can be transmitted between the computer and the mobile terminal device so that the efficiency of using the mobile terminal device may be enhanced and the file backup operation may be performed. As shown in FIG. 1, a mobile terminal device 11 is electrically connected with an electronic device 13, such as a computer, through a synchronizing bridging device 12. The synchronizing bridging device 12 has a connecting interface 121, and the electronic device 13 has a connecting interface module 131 and an operation system 132.

In use, the mobile terminal device 11 is first inserted into the synchronizing bridging device 12 and thus electrically connected with the synchronizing bridging device 12. Accordingly, the connecting interface 121 of the synchronizing bridging device 12 is connected with a connecting interface module of the electronic device 13. Herein, the connecting interface 121 may be a data transmission cable, which has a USB interface and may be connected with a USB connection port of the connecting interface module 131 so that the electrical connection is established. Thus, the signal of the mobile terminal device 11 may be transmitted to the operation system 132 of the electronic device 13 through the synchronizing bridging device 12, and the synchronous transmission may be established.

However, the data transmission cable 121 of the synchronizing bridging device 12 is not so convenient for the user with respect to the wireless transmission, and the spatial limitation still exists. An improved method is to add the wireless function to the synchronizing bridging device 12 so that the synchronizing bridging device 12 can communicate with the electronic device 13 in a wireless manner. In this case, however, the operation system 132, which is originally set to receive the signal coming from the connecting interface module 131, has to receive the wireless communication signal. So, the operation system 132 of the electronic device 13, such as the portion of the software for synchronization, inevitably has to be modified. In addition, once the operation system is modified, the electronic device 13 only may be used in conjunction with the wireless synchronizing bridging device 12 and cannot be used in conjunction with the original wired synchronizing bridging device 12.

Thus, it is an important subject of the invention to provide a wireless synchronizing bridging device, a wireless synchronizing bridging system and a wireless synchronizing bridging method, which can enhance the efficiency in use and enhance the product compatibility without modifying the operation system.

### SUMMARY OF THE INVENTION

In view of the foregoing, the invention is to provide a wireless synchronizing bridging device, a wireless synchronizing bridging system and a wireless synchronizing bridging method, which can enhance the efficiency in use and enhance the product compatibility without modifying an operation system.

To achieve the above, the invention discloses a wireless synchronizing bridging device operating in conjunction with a mobile terminal device and an electronic device. The mobile terminal device has a connecting interface. The wireless synchronizing bridging device includes a connecting interface module, a signal transforming module and a wireless transceiving module. The mobile terminal device is electrically connected with the connecting interface module through the connecting interface and transmits a connecting interface signal to the connecting interface module. The signal transforming module is electrically connected with the connecting interface module and transforms the connecting interface signal into a wireless communication signal. The wireless transceiving module is electrically connected with the signal transforming module and transmits the wireless communication signal to the electronic device.

To achieve the above, the invention also discloses a wireless synchronizing bridging system including a mobile terminal device, a wireless synchronizing bridging device and an electronic device. The mobile terminal device has a connecting interface and transmits a connecting interface signal through the connecting interface. The wireless synchronizing bridging device is electrically connected with the mobile terminal device through the connecting interface, transforms the connecting interface signal into a wireless communication signal, and transmits the wireless communication signal. The electronic device receives the wireless communication signal, and transforms the wireless communication signal into the connecting interface signal.

To achieve the above, the invention further discloses a wireless synchronizing bridging method applied to a mobile terminal device, a wireless synchronizing bridging device and an electronic device. The mobile terminal device has a connecting interface. The wireless synchronizing bridging method includes the steps of: transmitting a connecting interface signal to the wireless synchronizing bridging device through the connecting interface by the mobile terminal device; transforming the connecting interface signal into a wireless communication signal by the wireless synchronizing bridging device; transmitting the wireless communication signal to the electronic device by the wireless synchronizing bridging device; and transforming the wireless communication signal into the connecting interface signal by the electronic device.

As mentioned above, the wireless synchronizing bridging device, the wireless synchronizing bridging system and the wireless synchronizing bridging method according to the invention achieve the wireless communication function through the wireless transceiving module and thus enhance the efficiency in use for the user. In addition, the signal transforming module may be utilized to transform the wireless communication signal, which is received by the electronic device, into the connecting interface signal. Thus, the original setting of the operation system of the electronic device may be kept so that the electronic device can receive the connecting interface signal without any modification being made. In addition, the electronic device still can be applied to the wired synchronizing bridging device so as to enhance the product compatibility.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing applications of a mobile terminal device, a synchronizing bridging device and an electronic device according to the prior art;

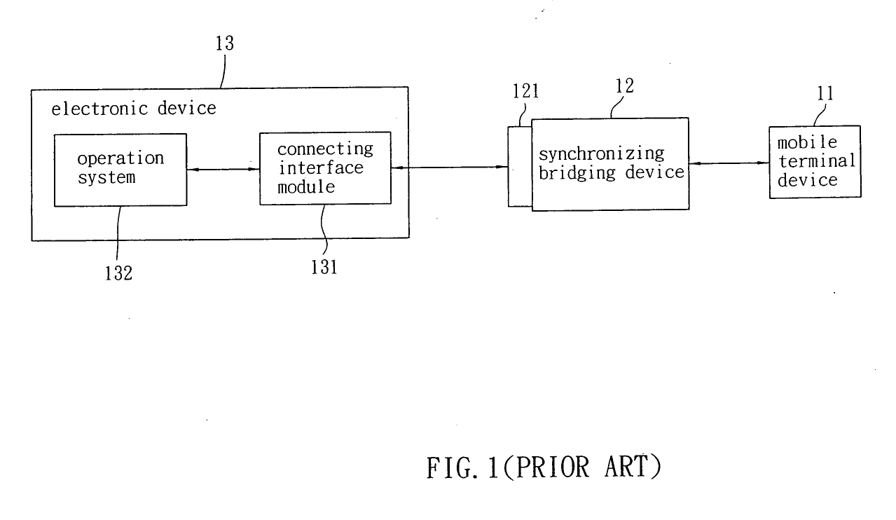

FIG. 2 is a schematic illustration showing a wireless synchronizing bridging system according to a preferred embodiment of the invention;

FIG. 3 is a schematic illustration showing another wireless synchronizing bridging system according to the preferred embodiment of the invention; and

FIG. 4 is a schematic illustration showing a wireless synchronizing bridging method according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

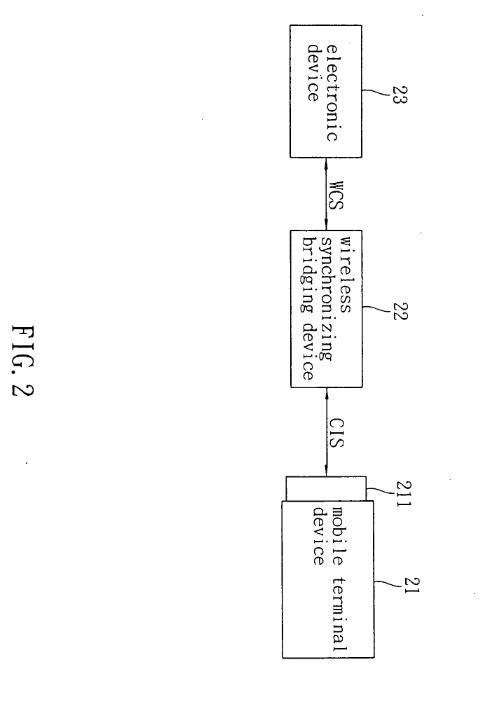

Referring to FIG. 2, a wireless synchronizing bridging system 2 according to the preferred embodiment of the invention includes a mobile terminal device 21, a wireless synchronizing bridging device 22 and an electronic device 23. In this embodiment, the mobile terminal device 21 may be a music player, an audio-video player, a mobile communication device or a personal digital assistant. The electronic device 23 may be a terminal device, such as a computer.

The mobile terminal device 21 has a connecting interface 211 and may transmit a connecting interface signal CIS through the connecting interface 211. Herein, the connecting interface 211 may be a USB interface, a 1394 interface or a Firewire interface. The wireless synchronizing bridging device 22 may be electrically connected with the mobile terminal device 21 through the connecting interface 211, and receive the connecting interface signal CIS. The wireless synchronizing bridging device 22 transforms the connecting interface signal CIS into a wireless communication signal WCS, and transmits the wireless communication signal WCS. Herein, the wireless communication signal WCS may accommodate the specification of the sub-communication protocol of IEEE 802.11, IEEE 802.11a/b/g/n, or the bluetooth communication protocol, for example.

The electronic device 23 may receive the wireless communication signal WCS and transform the wireless communication signal WCS into the connecting interface signal CIS. Thus, the connecting interface signal CIS transmitted from the mobile terminal device 21 may be reproduced in the electronic device 23. In addition, when the electronic device 23 wants to transmit the connecting interface signal CIS to the mobile terminal device 21, the connecting interface signal CIS may also be reproduced in the mobile terminal device 21 through the reverse transformation of the wireless synchronizing bridging device 22. Consequently, the mobile terminal device 21 and the electronic device 23 may achieve the synchronous transmission through the wireless synchronizing bridging device 22. That is, the data may be transmitted between the mobile terminal device 21 and the electronic device 23.

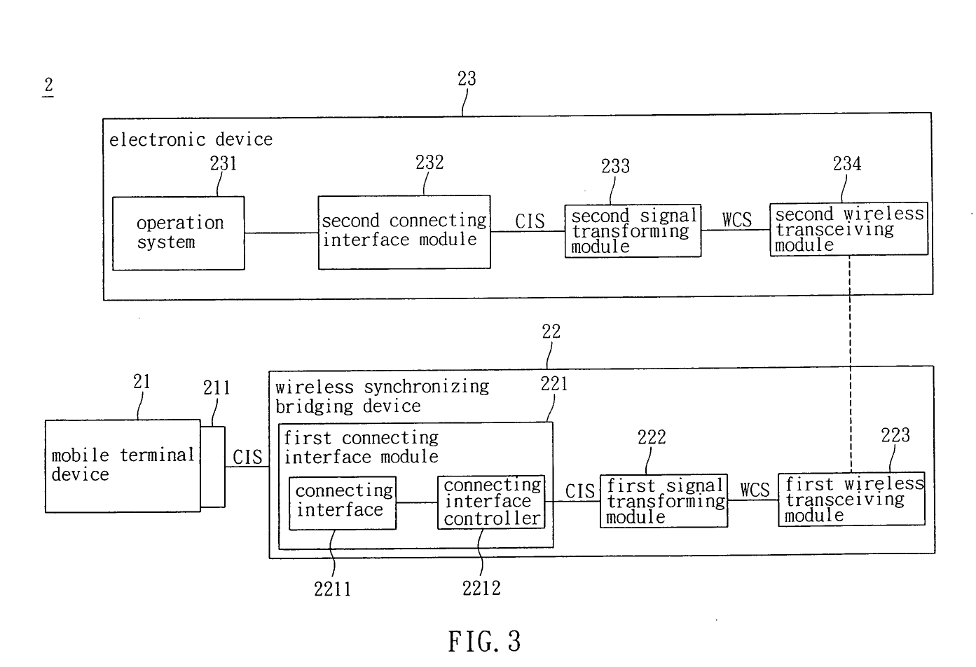

The wireless synchronizing bridging system 2 according to the embodiment of the invention will be described in detail with reference to FIG. 3.

The wireless synchronizing bridging device 22 has a first connecting interface module 221, a first signal transforming module 222 and a first wireless transceiving module 223. The first signal transforming module 222 is electrically connected with the first connecting interface module 221 and the first wireless transceiving module 223. In addition, the first connecting interface module 221 has a connecting interface 2211 and a connecting interface controller 2212 electrically connected with the connecting interface 2211.

When the connecting interface 211 of the mobile terminal device 21 is connected with the connecting interface 2211 of the first connecting interface module 221, the mobile terminal device 21 may be electrically connected with the wireless synchronizing bridging device 22, and the mobile terminal device 21 may transmit the connecting interface signal CIS to the wireless synchronizing bridging device 22. When the connecting interface controller 2212 detects that the connecting interface signal CIS enters from the connecting interface 2211, it transmits the connecting interface signal CIS to the first signal transforming module 222. The first signal transforming module 222 transforms the connecting interface signal CIS into the wireless communication signal WCS and transmits the wireless communication signal WCS to the first wireless transceiving module 223. The first wireless transceiving module 223 transmits the wireless communication signal WCS out in the form of electromagnetic waveforms.

The electronic device 23 has an operation system 231, a second connecting interface module 232, a second signal transforming module 233 and a second wireless transceiving module 234. The second wireless transceiving module 234 receives the wireless communication signal WCS transmitted from the first wireless transceiving module 223. The second signal transforming module 233 is electrically connected with the second wireless transceiving module 234 and transforms the wireless communication signal WCS into the connecting interface signal CIS. The second connecting interface module 232 is electrically connected with the second signal transforming module 233 and receives the connecting interface signal CIS. In this embodiment, the second connecting interface module 232, the first connecting interface module 221 and the connecting interface 211 of the mobile terminal device 21 have the same specification.

The operation system 231 of the electronic device 23 receives the connecting interface signal CIS through the second connecting interface module 232. Consequently, the connecting interface signal CIS transmitted by the mobile terminal device 21 may be reproduced in the electronic device 23. In the prior art using the wired synchronizing bridging device, the operation system 231 of the electronic device 23 is set to receive the signal coming from the second connecting interface module 232. In this embodiment, the operation system 231 still receives the signal coming from the second connecting interface module 232 although the wireless synchronizing bridging device is utilized. So, the operation system 231 needs not to be modified, and the electronic device 23 may be applied to either the wired synchronizing bridging device or the wireless synchronizing bridging device 22 of this embodiment.

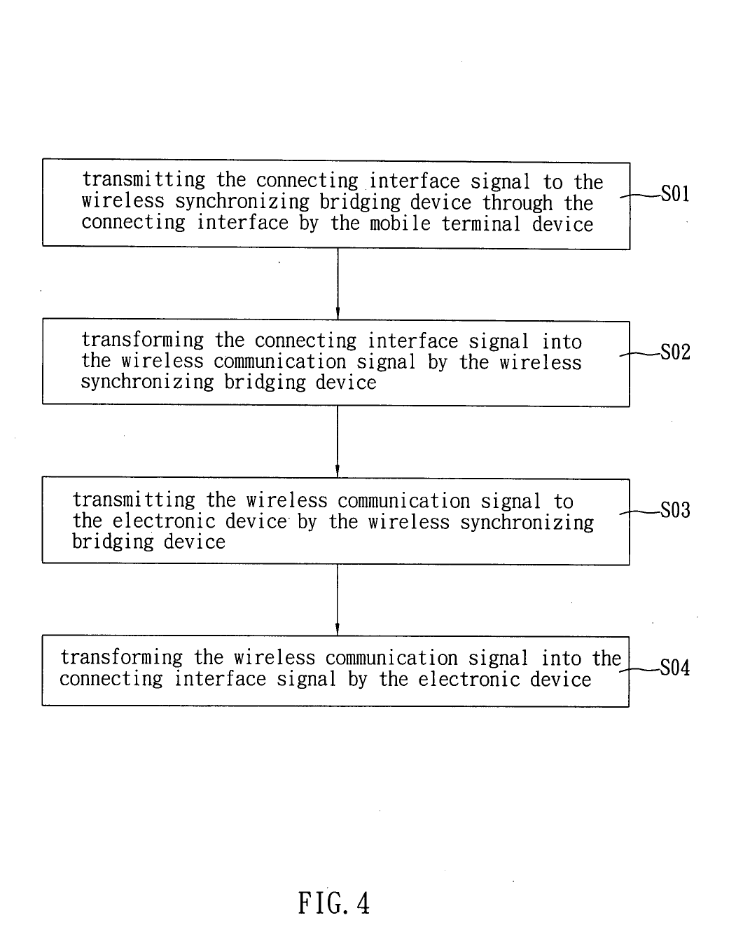

As shown in FIG. 4, the wireless synchronizing bridging method according to the preferred embodiment of the invention is applied to the wireless synchronizing bridging system 2. The wireless synchronizing bridging method includes the steps of: transmitting the connecting interface signal CIS to the wireless synchronizing bridging device 22 through the connecting interface 211 by the mobile terminal device 21 (S01); transforming the connecting interface signal CIS into the wireless communication signal WCS by the wireless synchronizing bridging device 22 (S02); transmitting the wireless communication signal WCS to the electronic device 23 by the wireless synchronizing bridging device 22 (S03); and transforming the wireless communication signal WCS into the connecting interface signal CIS by the electronic device 23 (S04). Because the wireless synchronizing bridging method has been described in detail in the wireless synchronizing bridging system 2 of the embodiment, detailed descriptions thereof will be omitted.

In summary, the wireless synchronizing bridging device, the wireless synchronizing bridging system and the wireless synchronizing bridging method according to the invention achieve the wireless communication function through the wireless transceiving module and thus enhance the efficiency in use for the user. In addition, the signal transforming module may be utilized to transform the wireless communication signal, which is received by the electronic device, into the connecting interface signal. Thus, the original setting of the operation system of the electronic device may be kept so that the electronic device can receive the connecting interface signal without any modification being made. In addition, the electronic device still can be applied to the wired synchronizing bridging device so as to enhance the product compatibility.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A wireless synchronizing bridging device operating in conjunction with a mobile terminal device and an electronic device, the mobile terminal device having a connecting interface, and the wireless synchronizing bridging device comprising:
a connecting interface module, wherein the mobile terminal device is electrically connected with the connecting interface module through the connecting interface and transmits a connecting interface signal to the connecting interface module;
a signal transforming module, which is electrically connected with the connecting interface module and transforms the connecting interface signal into a wireless communication signal; and
a wireless transceiving module, which is electrically connected with the signal transforming module and transmits the wireless communication signal to the electronic device.

2. The device according to claim 1, wherein the electronic device transforms the wireless communication signal into the connecting interface signal.

3. The device according to claim 1, wherein the connecting interface is a USB interface, a 1394 interface or a Firewire interface.

4. The device according to claim 1, wherein the wireless communication signal accommodates a specification of a sub-communication protocol of IEEE 802.11 or a bluetooth communication protocol.

5. The device according to claim 1, wherein the mobile terminal device is a music player or an audio-video player.

6. A wireless synchronizing bridging system, comprising:
a mobile terminal device, which has a connecting interface and transmits a connecting interface signal through the connecting interface;
a wireless synchronizing bridging device, which is electrically connected with the mobile terminal device through the connecting interface, transforms the connecting interface signal into a wireless communication signal, and transmits the wireless communication signal; and
an electronic device, which receives the wireless communication signal, and transforms the wireless communication signal into the connecting interface signal.

7. The system according to claim 6, wherein the connecting interface is a USB interface, a 1394 interface or a Firewire interface.

8. The system according to claim 6, wherein the wireless communication signal accommodates a specification of a sub-communication protocol of IEEE 802.11 or a bluetooth communication protocol.

9. The system according to claim 6, wherein the wireless synchronizing bridging device comprises:
a first connecting interface module for receiving the connecting interface signal from the mobile terminal device;
a first signal transforming module, which is electrically connected with the first connecting interface module and transforms the connecting interface signal into the wireless communication signal; and
a first wireless transceiving module, which is electrically connected with the first signal transforming module and transmits the wireless communication signal to the electronic device.

10. The system according to claim 6, wherein the electronic device comprises:
a second wireless transceiving module for receiving the wireless communication signal;
a second signal transforming module, which is electrically connected to the second wireless transceiving module and transforms the wireless communication signal into the connecting interface signal; and
a second connecting interface module, which is electrically connected to the second signal transforming module and receives the connecting interface signal.

11. The system according to claim 6, wherein the mobile terminal device is a music player or an audio-video player.

12. A wireless synchronizing bridging method applied to a mobile terminal device, a wireless synchronizing bridging device and an electronic device, wherein the mobile terminal device has a connecting interface, the method comprising the steps of:
transmitting a connecting interface signal to the wireless synchronizing bridging device through the connecting interface by the mobile terminal device;
transforming the connecting interface signal into a wireless communication signal by the wireless synchronizing bridging device;
transmitting the wireless communication signal to the electronic device by the wireless synchronizing bridging device; and
transforming the wireless communication signal into the connecting interface signal by the electronic device.

13. The method according to claim 12, wherein the connecting interface is a USB interface, a 1394 interface or a Firewire interface.

14. The method according to claim 12, wherein the wireless communication signal accommodates a specification of a sub-communication protocol of IEEE 802.11 or a bluetooth communication protocol.
